(19) United States
(12) Patent Application Publication
(10) Pub. No.: US 2015/0188171 A1
(43) Pub. Date: Jul. 2, 2015

(54) MICROBIOLOGICALLY PROTECTED FUEL CELL

(71) Applicant: MAG Aerospace Industries, LLC, Carson, CA (US)

(72) Inventors: Razmik B. Boodaghians, Glendale, CA (US); Yannick Brunaux, Saint Cyr L'Ecole (FR); Jean-Paul Libis, Bievres (FR); Andreas Hoogeveen, Enkhuizen (NL)

(21) Appl. No.: 14/410,689

(22) PCT Filed: Jun. 27, 2013
(86) PCT No.: PCT/US2013/048188

§ 371 Date: Dec. 23, 2014

Related U.S. Application Data
(60) Provisional application No. 61/665,977, filed on Jun. 29, 2012.
(60) Provisional application No. 61/694,322, filed on Aug. 29, 2012.

(51) Int. Cl. H01M 8/06; H01M 8/10

(52) U.S. Cl. CPC H01M 8/06; H01M 8/0662; H01M 8/1004; H01M 2008/1095; H01M 2250/20

(57) ABSTRACT

Disclosed is a fuel cell fluid purification system. The fuel cell fluid purification system can include a fuel cell system configured to receive a hydrogen input comprising hydrogen, receive an oxygen input comprising a first fluid having an initial concentration of oxygen, and convert the hydrogen input and the oxygen input so as to yield a number of outputs. The outputs can include a water output comprising water, a heat output comprising heat, an oxygen-depleted output comprising the first fluid having a concentration of oxygen lower than the initial concentration, and an electric output comprising electrical power. The fuel cell fluid purification system can also include a purification system configured to purify at least one of the oxygen input, the water output, or the oxygen-depleted output.

### CROSS-REFERENCES TO RELATED APPLICATIONS

This application claims the benefit of U.S. Provisional Application No. 61/665,977, entitled “FUEL CELL BYPRODUCTS,” filed Jun. 29, 2012 (Attorney Docket No. 54967/845370) and U.S. Provisional Application No. 61/694,322, entitled “PROTECTION OF FUEL CELL FROM AIRBORNE POLLUTANTS CONTAINED IN INTAKE AIR,” filed Aug. 29, 2012 (Attorney Docket No. 41052/850565), the entire disclosure of which is hereby incorporated herein by reference.

### BACKGROUND OF THE INVENTION

Vast numbers of people travel every day via aircraft, trains, buses and other commercial vehicles. Such commercial vehicles are often outfitted with components that are important for passenger comfort and satisfaction. For example, commercial passenger aircraft can have catering equipment, heating/cooling systems, lavatories, water heaters, power seats, passenger entertainment units, lighting systems, and other components. A number of these components on-board an aircraft require electrical power for their activation. Although many of these components are separate from the electrical components that are actually required to run the aircraft (i.e., the navigation system, fuel gauges, flight controls, and hydraulic systems), an ongoing concern with these components is their energy consumption. Frequently, such systems require more power than can be drawn from the aircraft engines' drive generators, necessitating additional power sources, such as a kerosene-burning auxiliary power unit (APU) (or by a ground power unit if the aircraft is not yet in flight). This power consumption can be rather large, particularly for long flights with hundreds of passengers. Additionally, use of aircraft power produces noise and CO₂ emissions, both of which are desirably reduced.

The relatively new technology of fuel cell systems provides a promising cleaner and quieter means to supplement energy sources already aboard commercial crafts. A fuel cell system combines a fuel source of compressed hydrogen with oxygen in the air to produce electrical energy as a main product. A fuel cell system has several outputs in addition to electrical power, and these other outputs often are not utilized and therefore become waste. For example, thermal power (heat), water and oxygen-depleted air (ODA) are produced as by-products. These by-products are far less harmful than CO2 emissions from current aircraft power generation processes.

Furthermore, commercial vehicles typically have the capacity to carry dozens to hundreds of people per trip. With such large numbers of people in a confined space, there is a risk of propogation of bacteria or other pathogens, which can negatively affect passengers and/or equipment. For example, if pathogens propagate into the fuel cell system, biofilm or other biological degradation can occur, resulting in reduction of performance or even failure of the system. This problem may also be exacerbated in commercial craft, which commonly undergo numerous and/or extended intervals of non-operation for maintenance or other servicing between trips, resulting in significant spans of time in which pathogen growth can go unchecked. As such, systems that may be implemented to counteract the spread of bacteria and other pathogens are desirable for safeguarding the health of passengers and/or the operational health of equipment aboard the craft.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

As an example embodiment, disclosed is a fuel cell fluid purification system. The fuel cell fluid purification system can include a fuel cell system configured to receive a hydrogen input comprising hydrogen, receive an oxygen input comprising a first fluid having an initial concentration of oxygen, and convert the hydrogen input and the oxygen input so as to yield a number of outputs. The outputs can include a water output comprising water, a heat output comprising heat, an oxygen-depleted output comprising the first fluid having a concentration of oxygen lower than the initial concentration, and an electric output comprising electrical power. The fuel cell fluid purification system can also include a purification system configured to purify at least one of the oxygen input, the water output, or the oxygen-depleted output.

In a further example embodiment, a fuel cell fluid purification system can include a fuel cell system further configured to receive a water input comprising water. The water input can be adapted for supplying water to a proton exchange membrane. The fuel cell fluid purification system can also include a purification system configured to purify at least one of the oxygen input, the water input, the water output, or the oxygen-depleted output.

As another example embodiment, disclosed is a method for operating a proton exchange membrane fuel cell system. The fuel cell system can be configured to receive a water input to supply water to a proton exchange membrane, a hydrogen input, and an air input. The fuel cell system can also be operable to produce at least electricity, heat, water, and oxygen depleted air. The method includes purifying at least one of the air input or the water input. The method also includes operating the fuel cell to produce electricity, heat, water, and oxygen depleted air.

For a fuller understanding of the nature and advantages of the present invention, reference should be made to the ensuing detailed description and accompanying drawings.

### BRIEF DESCRIPTION OF THE DRAWINGS

FIG. 1 is a diagram illustrating the inputs and outputs of a fuel cell system and non-limiting examples of how the outputs can be used.

FIG. 2 is a perspective front view of an ultraviolet purification assembly in accordance with various embodiments.

FIG. 3 is a diagram illustrating the inputs and outputs of a fuel cell system and non-limiting examples of how the inputs and/or outputs can be purified in accordance with various embodiments.

FIG. 4 is a diagram illustrating an alternate arrangement of the system illustrated in FIG. 3 in accordance with various embodiments.

FIG. 5 is a schematic illustrating a non-limiting example use of fuel cell byproducts in accordance with an embodiment.

FIG. 6 is a perspective view of a fuel cell system in accordance with various embodiments.

FIG. 7 is a table of common pollutants treated in accordance with various embodiments.

### DETAILED DESCRIPTION OF THE INVENTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

Disclosed herein are systems and processes for treating outputs and/or inputs of fuel cell systems used as a power source aboard aircraft. While the fuel cells are discussed for use in aircrafts, they are by no means so limited and may be used in buses, trains, spacecraft, or other forms of transportation equipped with fuel cell systems.

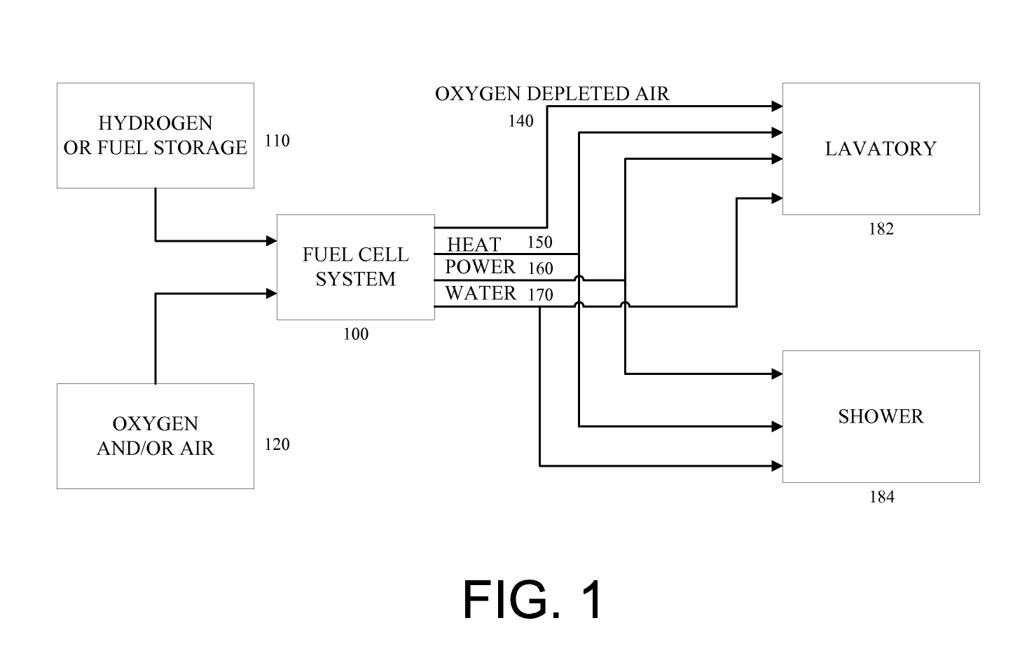

A fuel cell system is a device that converts chemical energy from a chemical reaction involving hydrogen or other fuel source and oxygen-rich gas (e.g., air) into electrical energy. As illustrated in FIG. 1, a fuel cell system 100 combines an input of hydrogen or another fuel source 110 with an input of oxygen 120 to generate electrical energy (power) 160. Along with the generated electrical energy 160, the fuel cell system produces water 170, thermal power (heat) 150, and oxygen-depleted air (ODA) 140 as by-products. As further illustrated in FIG. 1, some or all of the fuel cell output products of electrical energy 160, heat 150, water 170, and ODA 140 may be used to operate systems aboard the aircraft, such as, but not limited to, systems of a lavatory 182 or a shower 184 aboard the aircraft. Output products can additionally and/or alternatively be routed to other areas for use where such output products are useful, including, but not limited to, routing to aircraft wings for ice protection, to galleys, to passenger cabins, and/or to fuel tanks One or more than one output product can be utilized in any given location, and any given output product may be utilized in one or more locations. Exemplary, but non-limiting, examples of aircraft systems utilizing fuel cell output products are disclosed in International Patent Application No. PCT/US13/030638, entitled “FUEL CELL SYSTEM POWERED LAVATORY,” filed Mar. 13, 2013 (Applicant's File Reference No. 862890) and International Patent Application No. PCT/IB2013/052004, entitled “POWER MANAGEMENT FOR GALLEY WITH FUEL CELL,” filed Mar. 13, 2013 (Applicant's File Reference No. 862904) the entire disclosures of which are hereby incorporated herein by reference.

Any appropriate fuel cell system may be used, including, but not limited to, a Proton Exchange Membrane Fuel Cell (PEMFC), a Solid Oxide Fuel Cell (SOFC), a Molten Carbonate Fuel Cell (MCFC), a Direct Methanol Fuel Cell (DMFC), an Alkaline Fuel Cell (AFC), or a Phosphoric Acid Fuel Cell (PAFC). Any other existing or future fuel cell system technology, including, but not limited to, a hybrid solution, may also be used.

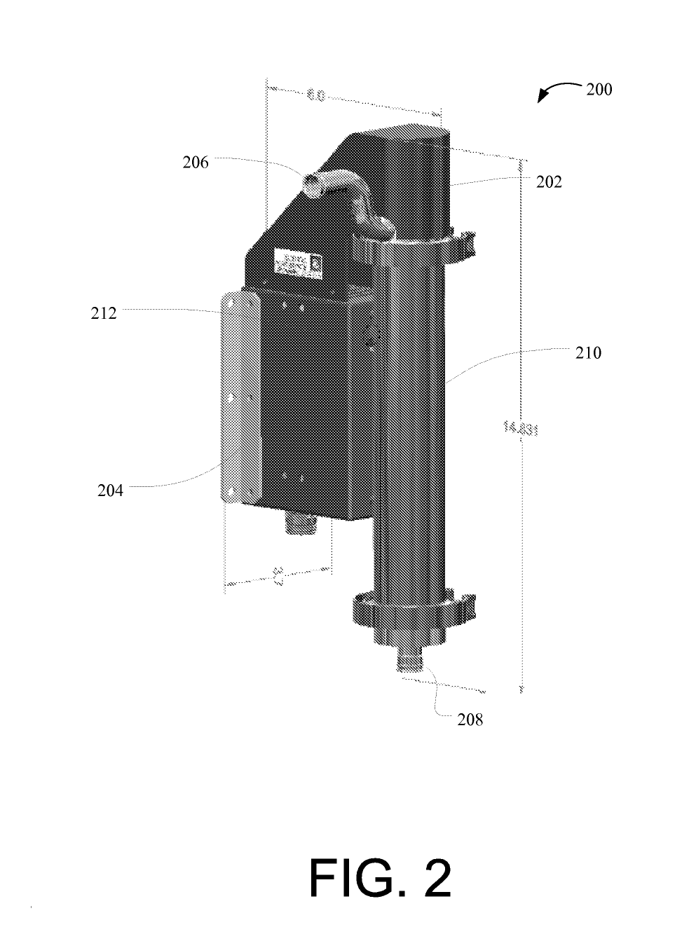

FIG. 2 is a perspective front view of a germicidal light treatment assembly 200 in accordance with various embodiments. In various embodiments, the germicidal light treatment assembly 200 includes a germicidal light source 202, a power supply 204, a fluid inlet 206, a fluid outlet 208, and a fluid manifold 210. The treatment assembly 200 can also optionally include a germicidal light sensor assembly 212. In embodiments, the power supply 204 supplies the power to operate the germicidal light source 202. The germicidal light source can be configured to operate at a germicidal wavelength that is effective to kill bacteria, viruses, and other pathogens borne in a fluid and disposed within a certain distance from the light source. The fluid can be a liquid and/or a gas, including, but not limited to, water and/or air. The germicidal light source may be one or more lamps and/or a Light Emitting Diode (LED) array. While any germicidal light source can be used, in various embodiments, the germicidal light source produces ultraviolet (UV) light, and in several embodiments, the germicidal light source is operated at a nominal ultraviolet wavelength of 254 nm.

In various embodiments, a fluid to be purified enters the germicidal light treatment assembly 200 via the fluid inlet 206. From the inlet 206, the fluid can be transported through the fluid manifold 210. While passing through the manifold 210, the fluid is exposed to the germicidal light from the germicidal light source 202 in order to neutralize pathogens within the fluid stream. After an amount of time providing sufficient exposure to light from the germicidal light source 202 to ensure a sufficient eradication level of the pathogens in the fluid, the purified fluid can be transported out of the germicidal light treatment assembly 200 via the fluid outlet 208. In embodiments, an optional germicidal light sensor assembly 212 is configured to detect levels of germicidal light within the manifold 210. In some embodiments, the detected levels of germicidal light can be utilized to determine and/or adjust the exposure to germicidal light provided in the manifold 210.

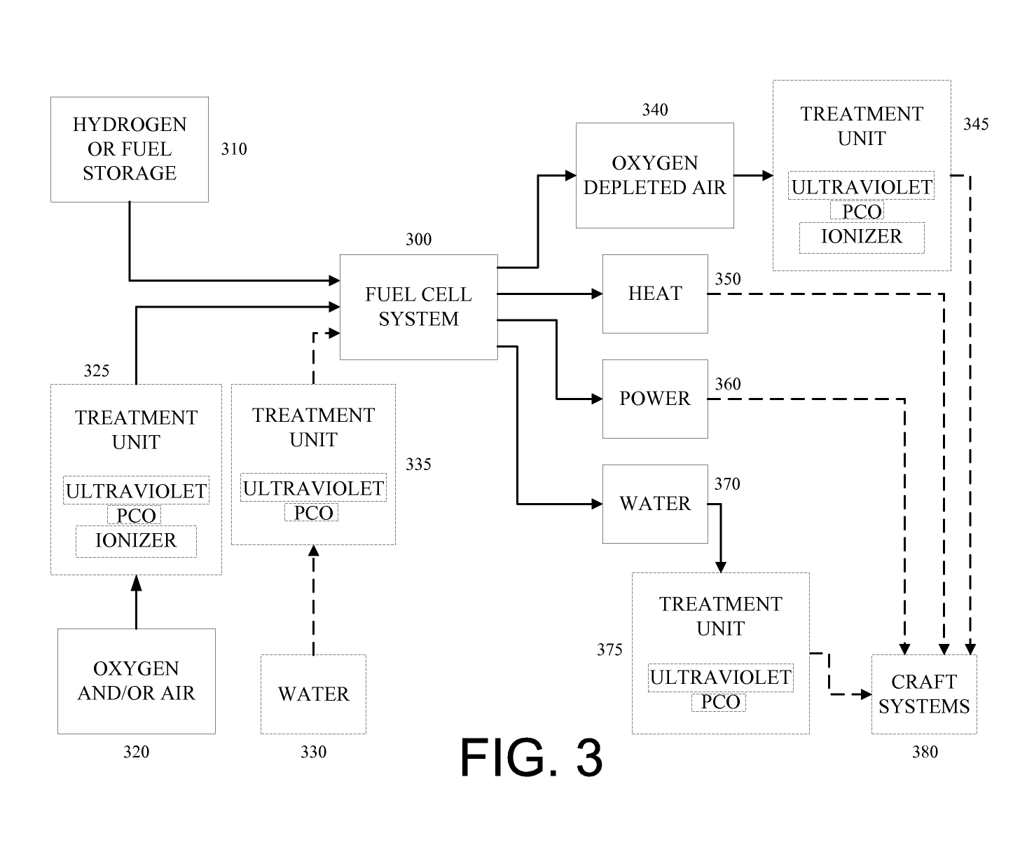

FIG. 3 is a diagram illustrating the inputs and outputs of a fuel cell system and non-limiting examples of how the inputs and/or outputs might be purified. Purifying one or more of the inputs or outputs can advantageously protect the fuel cell system equipment from biological degradation and/or make output products more operationally ready for other purposes. As a non-limiting example, the operation of a Proton Exchange Membrane (PEM) fuel cell system depends upon a sensitive polymer membrane maintained within certain hydration and temperature ranges; deviation from these ranges may result in reduction of performance or even rupture of the membrane. Purification of inputs contacting the membrane may protect the membrane by preventing bacterial growth which could otherwise cause formation of a biofilm that could degrade the membrane or otherwise interfere with efforts to maintain the membrane within its environmental tolerances. Even if pathogen growth is unlikely during operation of the fuel cell, such purification measures may provide a way to minimize the accumulation of pathogens that might grow during periods of non-operation of the fuel cell, such as when an aircraft is parked in between flights.

As illustrated in FIG. 3, in some embodiments, the oxygen-rich gas 320 to be used by the fuel cell system 300 is treated by passage through a treatment unit 325 prior to being delivered to the system 300. In embodiments, the treatment unit may include a germicidal light treatment assembly 200 as described with reference to FIG. 2, but the treatment unit 325 need not be so limited. Indeed, in some embodiments, the treatment unit 325 includes an ionizer utilizing charged particles to attract and trap pathogens. Alternatively, the treatment unit 325 can also utilize photocatalytic oxidation (PCO) to generate particles to trap pathogens. The treatment unit 325 can also utilize any other suitable purification method and may utilize more than one purification method at once. For example, the treatment unit 325 may use an ultraviolet light for both germicidal irradiation as well as for PCO. Also, the treatment unit 325 can utilize one or more types of purification devices and/or one or more purification methods.

In some embodiments, in addition to the oxygen supply 320 and the fuel supply 310, a supply of water 330 is provided to the fuel cell system 300. As a non-limiting example, a fuel cell system 300 may utilize a supply of water 330 to regulate the hydration level of the membrane in a PEM-type fuel cell system. In some embodiments, the supply of water 330 is treated by passage through a treatment unit 335 prior to being delivered to the system 300. While in some embodiments, treatment unit 335 utilizes ultraviolet germicidal light, the treatment unit 335 need not be so limited, but (similar to the treatment unit 325) can utilize one or more types of purification devices and/or one or more purification methods.

In some embodiments, the output product of the oxygen depleted gas 340 can be treated by passage through a treatment unit 345. While in some embodiments, treatment unit 345 utilizes ultraviolet germicidal light, the treatment unit 345 need not be so limited, but (similar to the treatment unit 325) can utilize one or more types of purification devices and/or one or more purification methods.

In some embodiments, the output product of water 370 can be treated by passage through a treatment unit 375. While in some embodiments, treatment unit 375 utilizes ultraviolet germicidal light, the treatment unit 375 need not be so limited, but (similar to the treatment unit 325) can utilize one or more types of purification devices and/or one or more purification methods.

While FIG. 3 illustrates a configuration of a fuel cell system 300 in which the supply of oxygen-rich gas 320, the supply of water 330, the output product of oxygen depleted air 340, and the output product of water 370 are each passed through respective treatment units (325, 335, 345, and 375), embodiments need not be so limited. Each of the treatment units (325, 335, 345, and 375) could be omitted without removing the resulting configuration from the scope of the present disclosure. As such, each of the treatment units (325, 335, 345, and 375) are shown in FIG. 3 using dashed lines. Similarly, the supply of water 330 could be omitted without removing the resulting configuration from the scope of the present disclosure. In embodiments, regardless of which of these features are omitted or included, one or more of the output products of the fuel cell system 300 (i.e., oxygen depleted air 340, heat 350, power 360, and/or water 370), can be optionally routed to provide resources to craft systems 380 (such as, but not limited to lavatory 182 and shower 184). Accordingly, in at least such embodiments, purifying one or more of the inputs or outputs can advantageously protect the operational health of the fuel cell system from biological degradation and/or make the output products more operationally ready for other purposes.

For example, purifying the output water 370 can prepare the water 370 to be used in a variety of applications onboard the aircraft. Uses include, but are not limited to, sanitary water for faucets expected to be used by passengers to wash hands and faces, water to flush toilets, water to supplement potable drinking water held in an aircraft potable water tank, cooling misters on passenger seating units, and/or other uses that can also potentially reduce the total volume of water loaded on aircraft prior to departure. Similarly, purifying the output oxygen depleted air 340 can prepare the ODA 340 to be used in a variety of applications onboard the aircraft. Uses include, but are not limited to, preheating water tanks on the coffee and/or tea makers, preheating food containers and/or trollies in the galley, sanitizing and deodorizing the lavatory by cycling bursts of the ODA through the lavatory, and/or supplying hot air for blower-style hand-dryers and/or surface dryers.

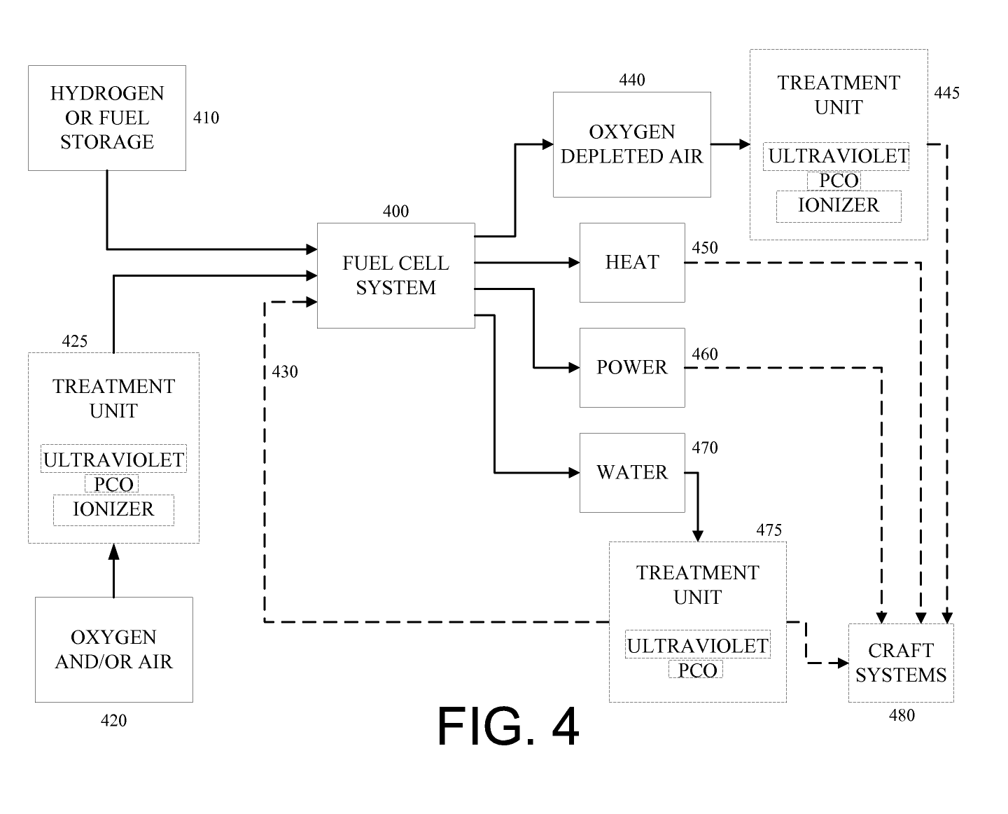

As illustrated in FIG. 4, in some embodiments, an amount of the water output 470 can be utilized to provide a water input 430 to the fuel cell system 400. In some embodiments, the output product of water 470 is treated by passage through a treatment unit 475 before use for the water input 430. While in some embodiments, treatment unit 475 utilizes ultraviolet germicidal light, the treatment unit 475 need not be so limited, but (similar to the treatment unit 325) can utilize one or more types of purification devices and/or one or more purification methods. In some embodiments, at least a portion of the output product water 470 that is purified through treatment unit 475 and that is not routed to the water input 430 is routed delivered to be utilized by other craft systems 480.

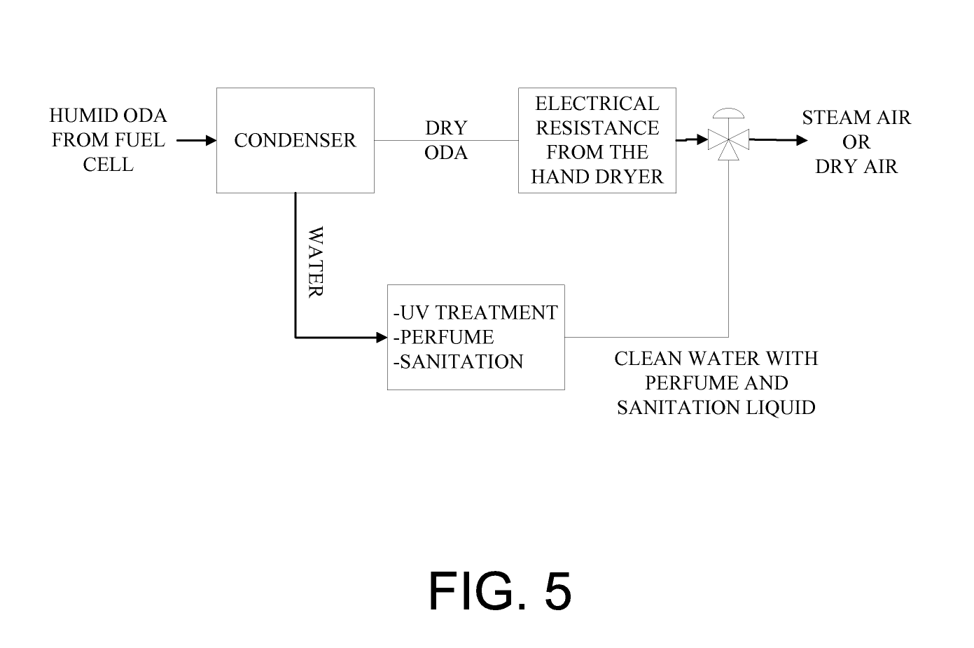

Although various aspects of this disclosure are directed to sanitation or cleaning through the use of ultraviolet germicidal light sources in conjunction with output products of a fuel cell, germicidal light sources and fuel cell products may be utilized for sanitation purposes either separately or together. For example, the ODA produced by the fuel cell can be used for drying hands with or without first being treated by a treatment unit comprising a germicidal light source. The ODA produced by the fuel cell can also be used for drying wet surfaces in the lavatory, galley, and/or aircraft cabin interior, regardless of prior UV treatment. As further examples, hot ODA and/or water products (e.g. steam) from the fuel cell may be used alone or combined with UV treatment to clean equipment or surfaces such as may be included in lavatories, galleys, sinks, and aircraft cabin. Additionally, as a substitute or complement to UV treatment the ODA can be treated by initially removing the moisture from the ODA and later raising its temperature, if desired. The schematic illustrated in FIG. 5 shows one such possible process including the removal of the moisture from ODA as well as the potential applications of the water removed (i.e., condensed water) after optional treatment with UV and/or being odorized. UV treatment can also be used alone (i.e., without supplementation by fuel cell products) to sanitize areas within the aircraft. For example, when the lavatory is not in use, a sliding UV treatment probe hidden inside a cabinet may be deployed over the toilet seat or counter surface to expose the surface to germicidal light for sanitation. Such a probe may also be utilized on food preparation surfaces in galleys or in other areas within the aircraft. Alternatively, larger banks of germicidal light sources can be utilized in place of probes in order to treat an entire area, such as a lavatory, when it is not occupied by a passenger.

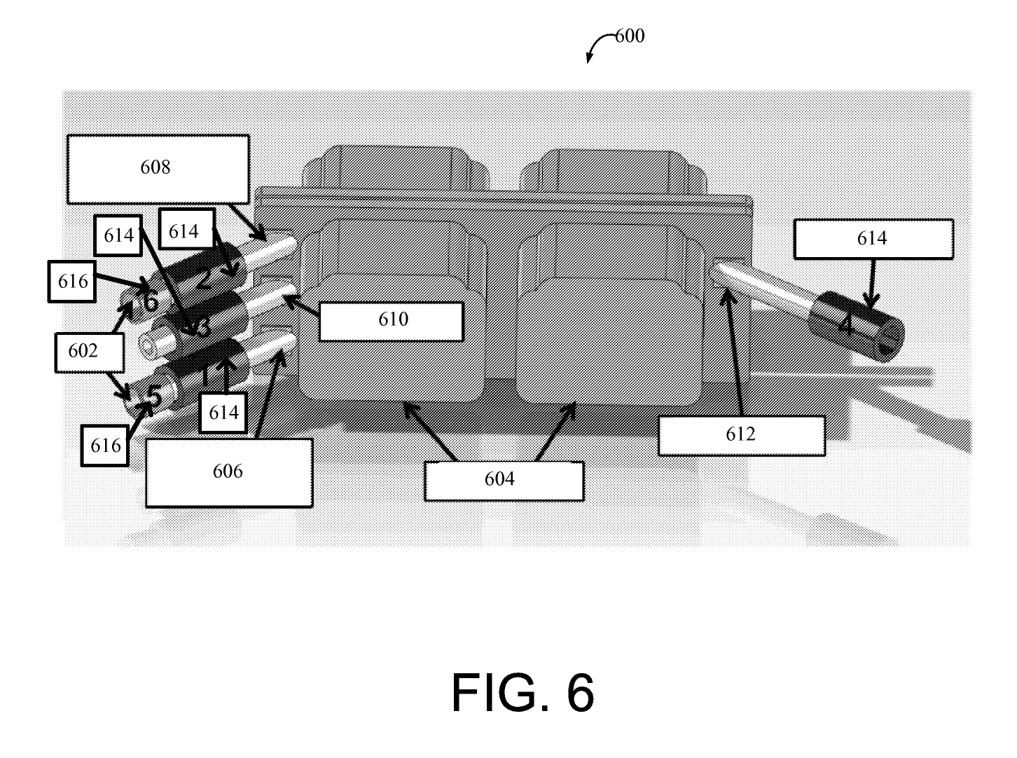

FIG. 6 is a perspective view of a fuel cell system in accordance with various embodiments. In some embodiments, a fuel cell system 600 can include a main cooling loop 602 for relaying water in and out of the fuel cell stacks 604 in order to exchange and/or transport heat 150 produced by the fuel cell system 600. The main cooling loop may include a water cooling inlet 606 and a water cooling outlet 608. In some embodiments, the main cooling loop 602 may be utilized to provide a water supply 330 to regulate the hydration level of the membrane in a PEM-type fuel cell system, but the main cooling loop 606 can also be distinct from a water supply 330. Furthermore, the main cooling loop 602 can be a closed loop. In alternate embodiments, the main cooling loop 602 is at least partially open. For example, if the main cooling loop 602 is open, the water cooling outlet 606 may provide water to other systems aboard the craft such as to the potable drinking water tank.

The fuel cell system 600 can also include an air inlet 610, which can provide the supply of oxygen-rich gas 320 to the fuel cell system 600. The fuel cell system 600 can also include an oxygen depleted air outlet 612, which can transport the oxygen depleted gas 340 produced by the fuel cell system 600. In the embodiment shown, the water cooling inlet 606, the water cooling outlet 608, the air inlet 610, and the oxygen depleted gas air outlet 612 are each outfitted with a treatment unit 614 to treat the fluid flowing through the respective inlet or outlet via ultraviolet irradiation and photocatalytic oxidation. However, the treatment units 614 need not be so limited, but each can utilize one or more purification methods and need not utilize exactly the same methods as another. In addition, in the embodiment shown, the water cooling inlet 606 and the water cooling outlet 608 are each also equipped with a second treatment unit 616, configured to prevent formation of mineral deposits or scales in the respective inlet or outlet using Template Assisted Crystallization. Treatment units utilizing Template Assisted Crystallization generally cause minerals to assume crystalline form, thereby preventing formation of deposits or scales resulting from accumulation of the minerals in ionic form. In various embodiments, the second treatment unit 616 can form part of the first treatment unit 614. Furthermore, Template Assisted Crystallization may be utilized as an additional or substitute purification method by any suitable treatment unit disclosed herein (e.g., treatment units 325, 335, 345, 375, 425, 445, 475, and 614).

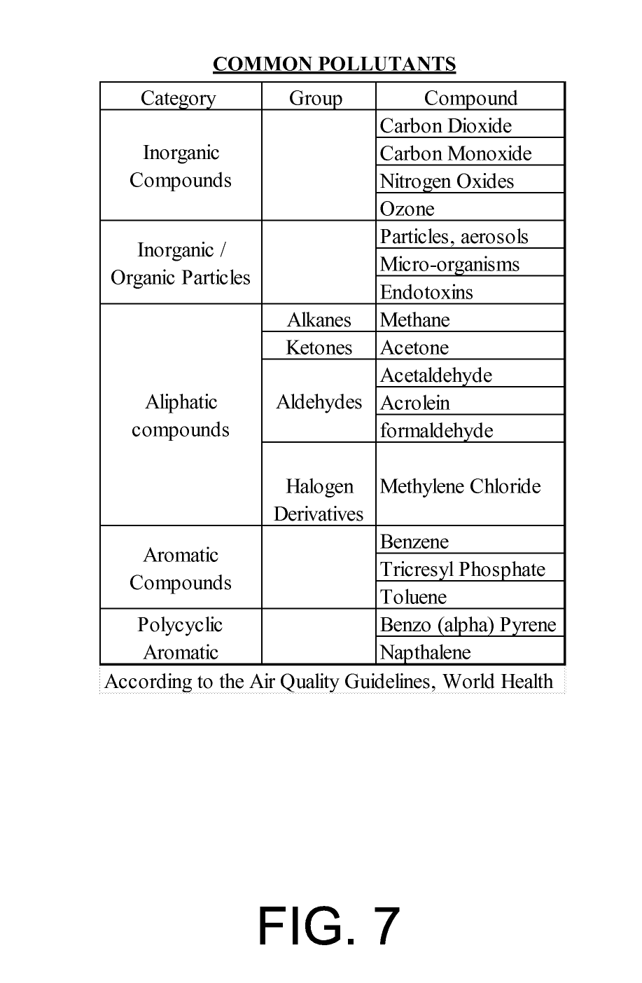

Treatment units as disclosed herein can be configured to treat, filter, and/or neutralize one or more of a wide variety of pollutants. FIG. 7 is a table of common pollutants treated in accordance with various embodiments. The table lists common pollutants according to the World Health Organization. Additionally, while treatment units as disclosed herein can be configured to treat, filter, and/or neutralize one or more or different combinations of the pollutants listed in the table, the listed pollutants are provided solely as examples of pollutants, and the capabilities of the treatment units are not limited to only treating these example pollutants. Furthermore, although a variety of methods have been disclosed by which treatment units may treat, filter, and/or neutralize pollutants, treatment units can also utilize other any suitable methods known or later developed for treating pollutants.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A fuel cell fluid purification system comprising:
(A) a fuel cell system configured to:
(i) receive a hydrogen input comprising hydrogen,
(ii) receive an oxygen input comprising a first fluid having an initial concentration of oxygen,
(iii) convert the hydrogen input and the oxygen input so as to yield:
(a) a water output comprising water,
(b) a heat output comprising heat,
(c) an oxygen-depleted output comprising the first fluid having a concentration of oxygen lower than the initial concentration, and
(d) an electric output comprising electrical power; and
(B) a purification system configured to purify at least one of the oxygen input, the water output, or the oxygen-depleted output.

2. The fuel cell fluid purification system of claim 1, wherein the purification system comprises a germicidal ultraviolet light source.

3. The fuel cell fluid purification system of claim 2, wherein the purification system further comprises a power supply and a conduit configured to convey a fluid to be purified through ultraviolet light provided by the germicidal ultraviolet light source.

4. The fuel cell fluid purification system of claim 2, wherein the purification system further comprises a UV light sensor assembly.

5. The fuel cell fluid purification system of claim 3, wherein the fluid to be purified comprises the oxygen input.

6. The fuel cell fluid purification system of claim 3, wherein the fluid to be purified comprises the oxygen-depleted output.

7. The fuel cell fluid purification system of claim 6, wherein the oxygen-depleted output after purification is adapted for use in systems aboard a craft.

8. The fuel cell fluid purification system of claim 3, wherein the fluid to be purified comprises output water.

9. The fuel cell fluid purification system of claim 8, wherein the water output after purification is adapted for use in systems aboard a craft.

10. The fuel cell fluid purification system of claim 1, wherein the purification system comprises an ionizer.

11. A fuel cell fluid purification system comprising:
(A) a fuel cell system configured to:
(i) receive a hydrogen input comprising hydrogen,
(ii) receive an oxygen input comprising a first fluid having an initial concentration of oxygen,
(iii) receive a water input comprising water, the water input adapted for supplying water to a proton exchange membrane,
(iv) convert the hydrogen input and the oxygen input so as to yield:
(a) a water output comprising water,
(b) a heat output comprising heat,
(c) an oxygen-depleted output comprising the first fluid having a concentration of oxygen lower than the initial concentration, and
(d) an electric output comprising electrical power; and
(B) a purification system configured to purify at least one of the oxygen input, the water input, the water output, or the oxygen-depleted output.

12. The fuel cell fluid purification system of claim 11, wherein the purification system comprises a germicidal ultraviolet light source, a power supply, and a conduit configured to convey a fluid to be purified through ultraviolet light provided by the germicidal ultraviolet light source, wherein the fluid to be purified comprises the water input.

13. The fuel cell fluid purification system of claim 11, wherein the water output supplies the water input and the purification system is configured to purify the water supplied from the water output to the water input.

14. A method for operating a proton exchange membrane fuel cell system, the fuel cell system configured to receive a water input to supply water to a proton exchange membrane, the fuel cell system configured to receive a hydrogen input, the fuel cell system configured to receive an air input, and the fuel cell system operable to produce at least electricity, heat, water, and oxygen depleted air, the method comprising:
purifying at least one of the air input or the water input; and
operating the fuel cell to produce electricity, heat, water, and oxygen depleted air.

15. The method for operating a proton exchange membrane fuel cell system of claim 14, further comprising purifying at least one of the air output or the water output.
